(19) United States
(12) Patent Application Publication
(10) Pub. No.: US 2002/0111985 A1
(43) Pub. Date: Aug. 15, 2002

(54) Data processing method

(76) Inventor: Christian Panis, Wien (AT)

Correspondence Address: JENKINS & WILSON, PA, 3100 TOWER BLVD, SUITE 1400, DURHAM, NC, 27707, US

(21) Appl. No.: 10/050,341

(22) Filed: Jan. 16, 2002

(30) Foreign Application Priority Data
Jan. 17, 2001 (DE) 10101949.1

(51) Int. Cl. G06F 9/00

(52) U.S. Cl. 709/106

(57) ABSTRACT

The invention provides a data processing device with a multiplicity of processors (P1-P5) which operate in parallel and to which a respective command (CMP1, CMP2, MOV1, MOV2, FSEL) for data processing can be supplied simultaneously. At least one of the processors (P5) can be supplied with a condition command (FSEL) which makes the execution of a further command (CMP1, CMP2, MOV1, MOV2) in at least one of the further processors (P1-P4) conditional on the condition command (FSEL).

The present invention relates to a data processing method using a multiplitity of processors which operate in parallel and to which a respective command for data processing is supplied simultaneously.

DE 36 50 413 T2 discloses a method for cancelling a command in a computer system which is structured and operates according to the pipeline method. However, in this known method the command is first executed and then cancelled, which increases the reduction in efficiency.

DE 44 34 895 C2 describes a computer system in which a conditional command causes a substitution command to store a different value in a register which is provided for that purpose. This is a superscalar architecture in which the hardware controls the sequencing and the execution of the commands.

EP 0 529 913 A2, WO 97/25671 A1 and DE 41 34 392 A1 describe computer systems in which a parallel command execution can be influenced, but a multiplicity of commands is executed simultaneously in each case.

During data processing by computer systems, the problem often occurs that different computational operations are to be carried out alternatively as a function of the content of a specific register.

FIG. 3 shows an example of a respective program structure.

In FIG. 3, IF . . . THEN—ELSE—END IF designates a conditional execution structure and ADD ( . . . ) designates various corresponding computational operations, here additions. In this example, it is firstly tested whether the content the register d14 is equal to “0”. In this is the case, the contents of the registers a0, a1, a2 are added together; and if this is not the case, the contents of the registers a1, a2, a3 are added together.

If a computer architecture with a single processor is present, this task is achieved by using conditional jumps and what are referred to flags. However, processing the program in this way is costly in terms of computing time.

For this reason, nowadays pipeline architectures, in which a plurality of processors of a computer are connected together to form a pipeline, are used for operations.

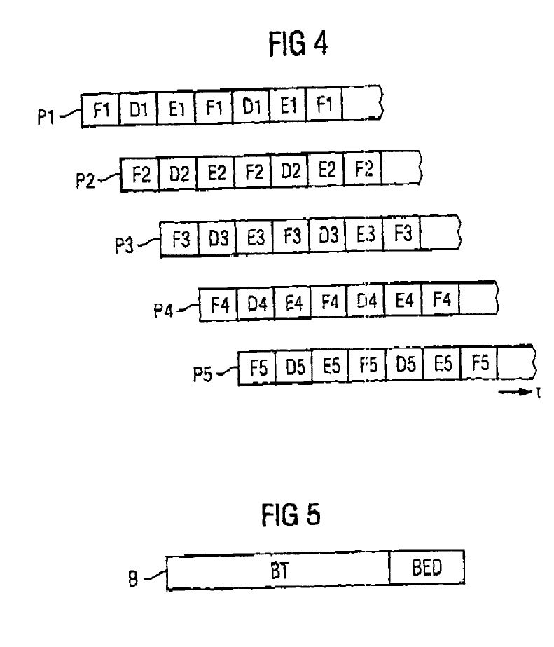

FIG. 4 shows an example of an known pipeline architecture in which five processors are connected together to form a pipeline.

In the example in FIG. 4, P1-P5 designate the five different processors. The commands are divided here in each case into three processing steps, namely call F1-F5, decoding D1-D5 and execution E1-E5.

The commands therefore pass through the processors P1-P5 offset with respect to one another in terms of the time t, said processors P1-P5 being thus engaged simultaneously by different commands.

In this context, it is known that the various commands B have their own command part 3T, onto which a condition part BED of typically several (for example 5) bits is appended, said condition part BED carrying the condition result, as shown in FIG. 5. However, such a structure makes all the commands longer, and is thus costly in terms of space.

The object on which the present invention is based is to provide a data processing device and a data processing method which have conditional processing of commands and which permit a better code density.

This object is achieved by means of the data processing method disclosed in claim 1.

The idea on which the present invention is based is that at least one of the processors can be supplied with a condition command which makes the execution of a further command in at least one of the further processors conditional on the condition command.

In other words, for one of the processors, a command is defined which provides the possibility of forming from said command in a conditional fashion a single further command, a plurality of further commands or all the further commands which is/are present simultaneously at the further processors.

In this way, short jumps can be prevented, the reduction in efficiency can be restricted by efficient control and, above all, a better code density can be achieved. In addition, this ensures a high degree of flexibility with few program memory overheads.

Preferred developments are the subject matter of the subclaims.

According to one preferred development the condition command has the effect that the computational result of one of the processors is not written back into a target register which is provided.

According to a further preferred development, the condition command has the effect that an address is not calculated.

According to a further preferred development, the condition command has the effect that a command is not executed by the at least one of the further processors.

According to a further preferred development, the further commands comprise arithmetic computational commands and/or move commands.

According to a further preferred development, the condition which is associated with the condition command is the same for all the further processors. For example, as a condition for the execution of all the commands, the content of a register is tested.

According to a further preferred development, the condition which is associated with the condition command is different for all the further processors. For example, as a condition for the execution of a respective command, the content of a respective different register is tested.

The present invention will be explained below by meant of a preferred exemplary embodiment and with reference to the appended drawings, in which:

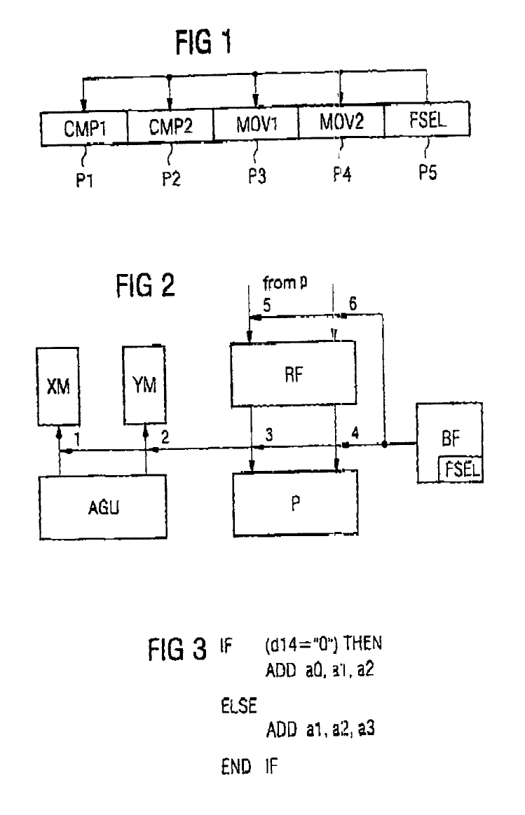

FIG. 1 shows a schematic view of the processors according to one embodiment of the present invention;

FIG. 2 shows a schematic view of the influence of the condition command in the embodiment of the present invention;

FIG. 3 shows an example of a corresponding program structure in which different computational operations are to be executed alternatively as a function of the content of a specific register;

FIG. 4 shows an example of a known pipeline architecture in which five processors are connected together to form a pipeline; and

FIG. 5 shows a known command structure with a condition part.

In the figures, identical reference symbols denote identical or functionally identical elements.

FIG. 1 shows a schematic view of the processors according to one embodiment of the present invention.

In FIG. 1, P1 to P5 designate a first to fifth processor, which operate in parallel, of a computer which is not illustrated in more detail. The first processor P1 can execute first arithmetic commands CMP1, for example addition commands. The second processor P2 can execute second arithmetic commands CMP2, for example likewise addition commands. The third processor P3 can execute first move commands MOV1. The fourth processor P4 can execute second move commands MOV2. The fifth processor P5 in configured to execute condition commands FSEL if such a command is fed to it.

Each condition command FSEL conditions the execution of all the further commands CMP1, CMP2, MOV1, MOV2 of the further processors P1 to P4, which is indicated by the four arrows in FIG. 1.

If no condition command FSEL is applied to the fifth processor P5, the latter ran execute program sequence control operations by means of corresponding commands.

With reference to the example of conditional processing, described in conjunction with figure 3, this would mean in the embodiment that the content of the register d14 has been tested in an earlier execution step, and the result is present in a corresponding register at the time of the processing according to FIG. 1, that is to say the condition is cancelled during the parallel execution of the five commands by the processors P1-P5 according to FIG. 1.

If CMP1 represents the addition a0, a1, a2, and CMP2 represents the addition a1, a2, a3, in the case d14 equal to “0” the condition command FSEL would have the effect that only the arithmetic command CMP1 is executed, but not the arithmetic command CMP2.

In an analogous fashion, the move commands MOV1, MOV2 can be controlled in a conditional fashion if they are to be executed simultaneously in the respective program. However, in the example according to FIG. 3, these two commands do not have any relevance.

FIG. 2 shows a schematic view of the influence of the condition command in the embodiment of the present invention.

In FIG. 2, AGU designates an address-generating unit, XM/YM designates an address memory, RF designates a register file, BF designates a branch file which contains the condition command FSEL, P designates one of the processors P1 to P5 according to FIG. 1, and reference symbols 1, 2, 3, 4, 5, 6 designate control points which can be influenced by the condition command FSEL from the branch file BF.

At control point 1, 2, the application of a specific address by the address-generating unit AGU to the address memory XM, YM can be prevented. At control point 3, 4, the application of a register content from the register file RF to the processor P can be prevented. At control point 5, 6, a register value can be prevented from being newly written into the register file RF by the processor P.

These are the most common influencing functions which can be associated with the condition command FSEL in order, for example, to make an arithmetic operation or a move operation conditional, and thus reduce inefficiency.

Although the present invention has been described above with reference to preferred exemplary embodiments, it is not restricted to these, but rather can be modified in various ways.

In particular, it is perfectly conceivable for further or other control functions to be associated with the condition command FSEL.

It is also possible for the condition associated with the condition command to be different for all the further processors, for example for a different register to be tested for each processor in order to decide on the activation/deactivation of its operation.

1. A data processing method using a multiplicity of processors (P1-P5) which operate in parallel and to which a respective command (CMP1, CMP2, MOV1, MOV2, FSEL) for data processing is supplied simultaneously, at least one of the processors (P5) being alternatively supplied with a program flow control command or a condition command (FSEL), the supplying of the condition command (FSEL) deactivating the parallel execution of a further command (CMP1, CMP2, MOV1, MOV2) in at least one of the further processors (P1-P4).

2. The data processing method as claimed in claim 1, wherein the supplying of the condition command (FSEL) has the effect that the computational result of one of the processors (P1, P2) is not written back into a target register (RF) which is provided.

3. The data processing method as claimed in claim 1 or 2, wherein the supplying of the condition command (FSEL) has the effect that an address is not calculated.

4. The data processing method as claimed in claim 1, 2 or 3, wherein the supplying of the condition command (FSEL) has the effect that a command is not executed by the at least one of the further processors (P1-P4).

5. The data processing method as claimed in one of the preceding claims, wherein the further commands (CMP1, CMP2, MOV1, MOV2) comprise arithmetic computational commands and/or move commands.

6. The data processing method as claimed in one of the preceding claims, wherein the condition which is associated with the condition command (FSEL) is the same for all the further processors (P1-P4).

7. The data processing method as claimed in one of the preceding claims, wherein the condition which is associated with the condition command (FSEL) is different for all the further processors (P1-P4).
